(19) United States
(12) Patent Application Publication
(10) Pub. No.: US 2025/0030670 A1
(43) Pub. Date: Jan. 23, 2025

(54) INFORMATION PROCESSING SYSTEM AND NON-TRANSITORY COMPUTER READABLE MEDIUM STORING INFORMATION PROCESSING PROGRAM

(71) Applicant: FUJIFILM Business Innovation Corp., Tokyo (JP)

(72) Inventor: Keisuke KOMATSUBARA, Kanagawa (JP)

(73) Assignee: FUJIFILM Business Innovation Corp., Tokyo (JP)

(21) Appl. No.: 18/444,775

(22) Filed: Feb. 19, 2024

(30) Foreign Application Priority Data
Jul. 19, 2023 (JP) 2023-117857

(51) Int. Cl. H04L 9/40; H04L 9/32

(52) U.S. Cl. CPC H04L 63/0428; H04L 9/321

(57) ABSTRACT

An information processing system includes a processor configured to, in a case where a request to resolve a host name is received, request an encrypted name resolution client server that performs name resolution using encrypted communication with an encrypted name resolution server to resolve the host name.

### CROSS-REFERENCE TO RELATED APPLICATIONS

This application is based on and claims priority under 35 USC 119 from Japanese Patent Application No. 2023-117857 filed Jul. 19, 2023.

### BACKGROUND

### (i) Technical Field

The present invention relates to an information processing system and a non-transitory computer readable medium storing an information processing program.

### (ii) Related Art

JP2020-167619A discloses a communication apparatus that can transmit data to the outside via a plurality of different communication interfaces. The communication apparatus includes a first DNS client having a designated DNS server accessible via a first communication interface for name resolution, a second DNS client having a designated DNS server accessible via a second communication interface for name resolution, and a communication application that transmits data to a destination designated by a host name. In a case where data is transmitted to the destination designated by the host name via the first communication interface, the communication application requests the first DNS client to resolve the host name. In a case where data is transmitted via the second communication interface, the communication application requests the second DNS client to resolve the host name.

Further, JP2021-162778A discloses a communication apparatus including: a setting unit that sets whether or not to use encrypted communication for name resolution as an operation setting of the communication apparatus: and a communication control unit that, in a case where the resolution of a host name requested by an application is performed, performs control to request a first DNS server to resolve the host name via an encrypted communication path established with the first DNS server on the basis of at least that the setting unit sets to use the encrypted communication and to request a second DNS server to resolve the host name in plain text on the basis of that the setting unit sets not to use the encrypted communication.

### SUMMARY

Aspects of non-limiting embodiments of the present disclosure relate to an information processing system and a non-transitory computer readable medium storing an information processing program that can request an encrypted name resolution server to resolve a host name without implementing an encrypted name resolution client application in an information processing system.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to, in a case where a request to resolve a host name is received, request an encrypted name resolution client server that performs name resolution using encrypted communication with an encrypted name resolution server to resolve the host name.

### BRIEF DESCRIPTION OF THE DRAWINGS

Exemplary embodiment(s) of the present invention will be described in detail based on the following figures, wherein:

FIG. 1 is a diagram illustrating a schematic configuration of an image forming system according to the present exemplary embodiment;

FIG. 2 is a block diagram illustrating a hardware configuration of an image forming apparatus illustrated in FIG. 1;

FIG. 3 is a block diagram illustrating a hardware configuration of an external DoH client server illustrated in FIG. 1;

FIG. 4 is a block diagram illustrating hardware configurations of an internal file server, an internal DNS server, an external file server, an external DNS server, and an external DoH server illustrated in FIG. 1;

FIG. 5 is a flowchart illustrating a flow of a name resolution request process of the image forming apparatus illustrated in FIG. 1;

FIG. 6 is a flowchart illustrating a flow of an authentication process of the external DoH client server illustrated in FIG. 1; and

FIG. 7 is a flowchart illustrating a flow of encrypted name resolution of the external DoH client server illustrated in FIG. 1.

### DETAILED DESCRIPTION

Hereinafter, an exemplary embodiment will be described with reference to the drawings. Further, in the drawings, identical or equivalent components and portions are denoted by identical reference numerals. In addition, the dimensional ratios in the drawings are exaggerated for convenience of description and may differ from the actual ratios.

### Overview of Image Forming System

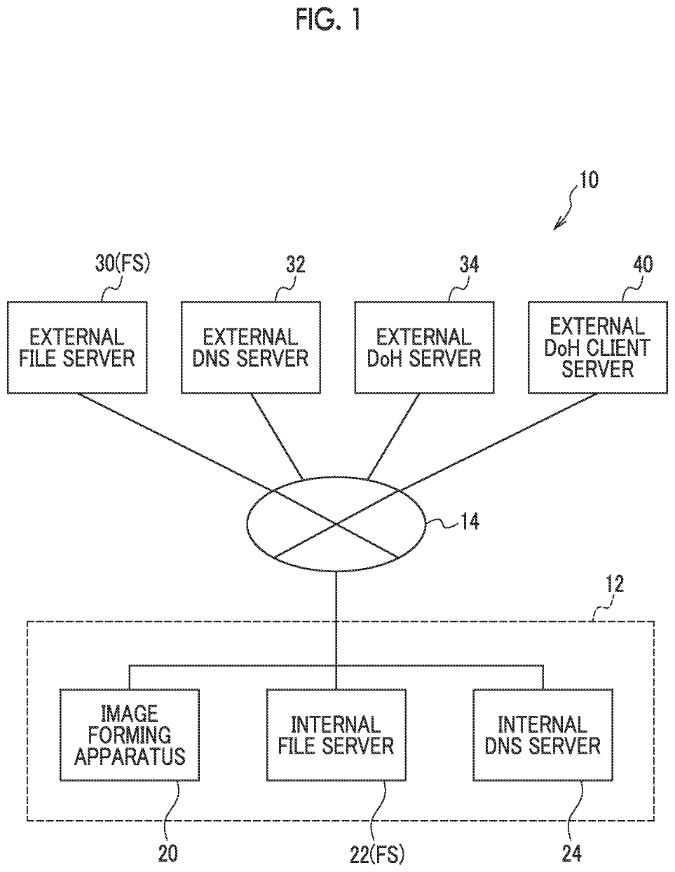

FIG. 1 illustrates an image forming system 10 according to the present exemplary embodiment. The image forming system 10 includes an image forming apparatus 20, an internal file server 22, an internal DNS server 24, an external file server 30, an external DNS server 32, an external DoH server 34, and an external DoH client server 40.

The image forming apparatus 20, the internal file server 22, and the internal DNS server 24 are connected to, for example, an internal network 12. The internal network 12 is a network (local area network) that is operated and managed by, for example, a specific company organization. Further, the external file server 30, the external DNS server 32, the external DoH server 34, and the external DoH client server 40 are connected to the internal network 12 via an external network 14 such as the Internet.

Furthermore, the image forming apparatus 20 is an example of an information processing apparatus and an information processing system. In addition, the internal DNS server 24 is an example of an internal name resolution server, and the external DNS server 32 is an example of an external name resolution server. Further, the external DoH server 34 is an example of an external encrypted name resolution server, and the external DoH client server 40 is an example of an external encrypted name resolution client server and the information processing system. Here, the term “system” in the present exemplary embodiment is a concept including both a system that is configured by a plurality of apparatuses and a system that is configured by a single apparatus.

Further, for example, FIG. 1 illustrates one image forming apparatus 20, one internal file server 22, one internal DNS server 24, one external file server 30, one external DNS server 32, one external DoH server 34, and one external DoH client server 40. However, a plurality of image forming apparatuses 20, a plurality of internal file servers 22, a plurality of internal DNS servers 24, a plurality of external file servers 30, a plurality of external DNS servers 32, a plurality of external DoH servers 34, and a plurality of external DoH client servers 40 may be provided.

### Image Forming Apparatus

The image forming apparatus 20 is, for example, a printing apparatus that has an image printing function of acquiring image data from the internal file server 22 or the external file server 30 and printing the acquired image data on a recording medium, such as paper, on the internal network 12. The image forming apparatus 20 may be, for example, a multifunction machine having at least one of a plurality of functions, such as an image reading (scanning) function, an image copy function, and an image transmission (facsimile) function, in addition to the above-described image printing function.

### Internal File Server

The internal file server 22 is a file server that stores image data and the like on the internal network 12. The internal file server 22 can transmit and receive various types of data, such as image data, to and from the image forming apparatus 20 via the internal network 12.

### Internal DNS Server

The internal DNS server 24 is a domain name system (DNS) server that performs host name resolution on the internal network 12. For example, in response to a request from the image forming apparatus 20, the internal DNS server 24 resolves a host name on the internal network 12 and transmits address information (IP address) corresponding to the host name as a name resolution result of the host name to the image forming apparatus 20.

In addition, in response to a request from the image forming apparatus 20, the internal DNS server 24 may request the external DNS server 32, which will be described below, to resolve the host name and transmit the name resolution result of the host name received from the external DNS server 32 to the image forming apparatus 20.

### External File Server

The external file server 30 is a file server that stores image data and the like on the external network 14. The external file server 30 can transmit and receive various types of data to and from the image forming apparatus 20 via the external network 14 and the internal network 12.

Further, hereinafter, for convenience of description, the internal file server 22 and the external file server 30 are collectively referred to as a file server FS.

### External DNS Server

The external DNS server 32 is a DNS server that resolves the host name on the external network 14. Further, the external DNS server 32 is, for example, a public DNS server. For example, in response to a request from the image forming apparatus 20 or the internal DNS server 24, the external DNS server 32 resolves the host name on the external network 14 and transmits the name resolution result of the host name to the image forming apparatus 20 or the internal DNS server 24.

### External DoH Server

The external DoH server 34 is a DoH server that resolves the host name using DNS over HTTPS (DoH) as encrypted communication on the external network 14. The external DoH server 34 is, for example, a public DoH server.

For example, in response to a request from the image forming apparatus 20 or the external DoH client server 40, the external DoH server 34 resolves the host name on the external network 14 and transmits the name resolution result of the host name to the image forming apparatus 20 or the external DoH client server 40. In this case, the external DoH server 34 uses encrypted communication using DoH with the image forming apparatus 20, the external DoH client server 40, or another DoH server.

### External DoH Client Server

The external DoH client server 40 is a DoH client server that provides a DoH client service for using the external DoH server 34 on the external network 14. The external DoH client server 40 is, for example, a cloud server.

For example, in response to a request from the image forming apparatus 20, the external DoH client server 40 requests the external DoH server 34 to resolve the host name using encrypted communication and transmits the name resolution result of the host name received from the external DoH server 34 to the image forming apparatus 20. In this case, the external DoH client server 40 uses encrypted communication using DoH with the external DoH client server 40.

Further, the external DoH client server 40 has an authentication function of authenticating an account of the DoH client service. Specifically, the external DoH client server 40 receives, for example, authentication information of the account from the image forming apparatus 20. Then, in a case where the authentication information of the account received from the image forming apparatus 20 is matched with the authentication information of the account registered in advance, the external DoH client server 40 determines that the authentication has succeeded and transmits information indicating the success, an access token, and the like to the image forming apparatus 20.

On the other hand, in a case where the received authentication information of the account is not matched with the authentication information of the account registered in advance, the external DoH client server 40 determines that the authentication has failed and transmits information indicating the failure to the image forming apparatus 20.

### Hardware Configuration of Image Forming Apparatus

Next, a hardware configuration of the image forming apparatus 20 will be described.

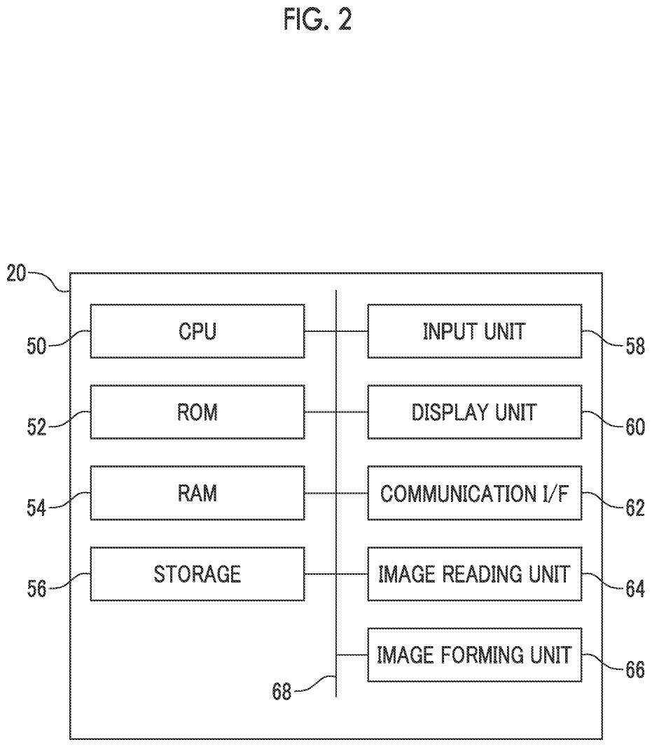

As illustrated in FIG. 2, the image forming apparatus 20 includes each of configurations of a central processing unit (CPU) 50, a read only memory (ROM) 52, a random access memory (RAM) 54, a storage 56, an input unit 58, a display unit 60, a communication interface (I/F) 62, and an image reading unit 64, and an image forming unit 66. The configurations are connected to communicate with one another via a bus 68.

The CPU 50 is a central processing unit and executes various programs or controls each unit. That is, the CPU 50 reads out a program from the ROM 52 or the storage 56 and executes the program using the RAM 54 as a work area. The CPU 50 controls each of the above-described configurations and performs various types of arithmetic processing according to the program recorded on the ROM 52 or the storage 56. In addition, the CPU 50 is an example of a processor.

The ROM 52 stores various information processing programs and various types of data. The RAM 54 temporarily stores the program or the data as the work area of the CPU 50. The RAM 54 also functions as a cache that stores the access token received from the external DoH client server 40, an expiration date of the access token, and the like. In addition, the RAM 54 is an example of a storage unit.

The storage 56 is configured by a hard disk drive (HDD) or a solid state drive (SSD) and stores various programs including an operating system and various types of data.

The storage 56 stores a World Wide Web (Web) browser application, a DNS client application, and a DoH client application and stores setting information of the Web browser application, the DNS client application, and the DoH client application.

The storage 56 stores, as setting information of the image forming apparatus 20, information indicating whether or not a process (DoH function) of resolving the host name using DoH is valid and information indicating whether a process of requesting the external DoH client server 40 to resolve a name is valid (information indicating whether or not the external DoH client server 40 is available). The setting information of the image forming apparatus 20 is appropriately set by, for example, an administrator or a user of the image forming apparatus 20.

The ROM 52 or the storage 56 stores a name resolution program for resolving the host name of the file server FS in a case of accessing the file server FS. In addition, the name resolution program is an example of the information processing program.

The input unit 58 includes a pointing device, such as a mouse, and a keyboard and is used to perform various inputs. The display unit 60 is, for example, a liquid crystal display and displays various types of information. The display unit 60 may be a touch panel type and may function as the input unit 58.

The communication I/F 34 is an interface for communication with other apparatuses. For example, a standard, such as Ethernet (Registered Trademark), FDDI, or Wi-Fi (Registered Trademark), is used.

The image reading unit 64 optically reads image data from a document or the like. The image forming unit 66 prints the image data read by the image reading unit 64 or the image data acquired from the file server FS on a recording medium such as paper.

### Hardware Configuration of External DoH Client Server

Next, a hardware configuration of the external DoH client server 40 will be described.

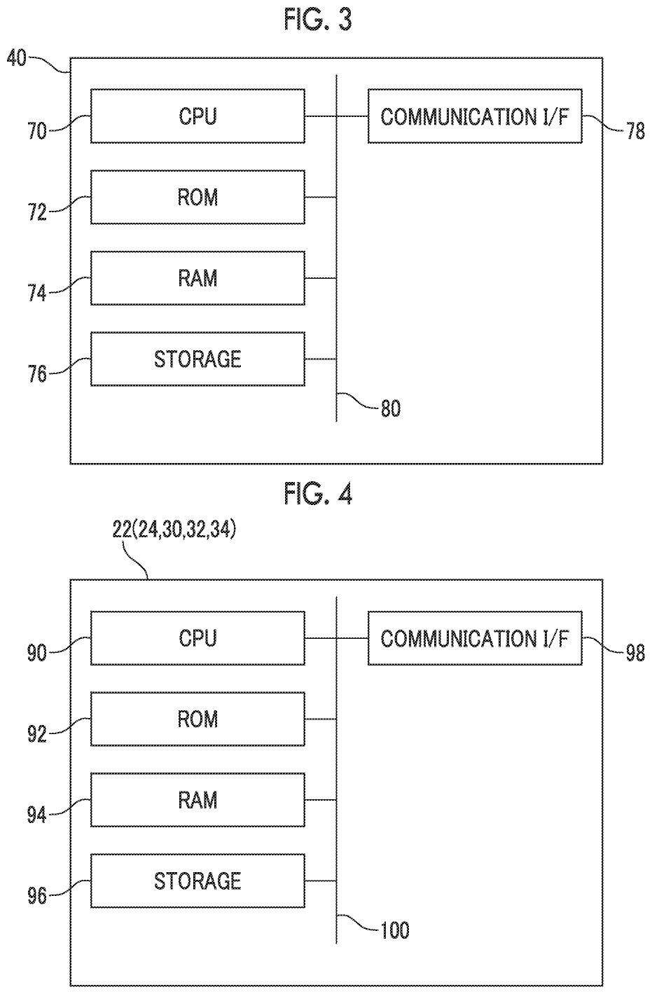

As illustrated in FIG. 3, the external DoH client server 40 has each of configurations of a CPU 70, a ROM 72, a RAM 74, a storage 76, and a communication I/F 78. The configurations are connected to communicate with one another via a bus 80.

The CPU 70 is a central processing unit and executes various programs or controls each unit. That is, the CPU 70 reads out a program from the ROM 72 or the storage 76 and executes the program using the RAM 74 as a work area. The CPU 70 controls each of the configurations and performs various types of arithmetic processing according to the program recorded on the ROM 72 or the storage 76. In addition, the CPU 70 is an example of the processor.

In addition, the ROM 72 or the storage 76 according to the present exemplary embodiment stores a name resolution request program for requesting the external DoH server 34 to resolve the host name using encrypted communication (DoH) on the basis of a request from the image forming apparatus 20. In addition, the name resolution request program is an example of the information processing program.

The ROM 72 stores various information processing programs and various types of data. The RAM 74 temporarily stores the program or the data as the work area of the CPU 70. The RAM 74 also functions as a DNS cache that stores the name resolution result received from the external DoH server 34. The RAM 74 is an example of the storage unit.

The storage 76 is configured by an HDD or an SSD and stores various programs including the operating system and various types of data. In addition, the storage 76 stores the DoH client application and stores the setting information of the DoH client application is stored.

An authentication information database is stored in the storage 76. The authentication information database is a database in which the authentication information of an account for using the external DoH client server 40 is registered. The authentication information database stores, for example, authentication information including an ID for identifying an account, a password, and the like in association with each account.

An access token management database is stored in the storage 76. The access token management database is a database that manages an access token issued to an account whose authentication has succeeded. The access token management database stores an ID of the account whose authentication has succeeded, an access token, an expiration date of the access token, and the like in association with each account.

An access restriction database is stored in the storage 76. The access restriction database is a database that manages access restrictions of the host name. The access restriction database stores, for example, the host name whose access is restricted in association with each account.

The communication I/F 78 is an interface for communication with other apparatuses. For example, a standard, such as Ethernet (Registered Trademark), FDDI, or Wi-Fi (Registered Trademark), is used.

### Hardware Configuration of Other Servers

Next, hardware configurations of the internal file server 22, the internal DNS server 24, the external file server 30, the external DNS server 32, and the external DoH server 34 will be described.

In addition, the internal file server 22, the internal DNS server 24, the external file server 30, the external DNS server 32, and the external DoH server 34 are configured by a general computer or a server apparatus. Therefore, hereinafter, the hardware configuration of the internal file server 22 will be described, and a description of the hardware configurations of the external file server 30, the external DNS server 32, and the external DoH server 34 will be omitted as appropriate.

As illustrated in FIG. 4, the internal file server 22 has each of configurations of a CPU 90, a ROM 92, a RAM 94, a storage 96, and a communication I/F 98. The configurations are connected to communicate with one another via a bus 100.

The CPU 90 is a central processing unit and executes various programs or controls each unit. That is, the CPU 90 reads out a program from the ROM 92 or the storage 96 and executes the program using the RAM 94 as a work area. The CPU 90 controls each of the configurations and performs various types of arithmetic processing according to the program recorded on the ROM 92 or the storage 96. In the present exemplary embodiment, a cloud program is stored in the ROM 92 or the storage 96. In addition, the CPU 90 is an example of the processor.

The ROM 92 stores various programs and various types of data. The RAM 94 temporarily stores the program or the data as the work area. In addition, the RAM 94 is an example of the storage unit. The storage 96 is configured by an HDD or an SSD and stores various programs including the operating system and various types of data.

Further, a printing image database is stored in the storages 96 of the internal file server 22 and the external file server 30. The printing image database is a database that stores image data to be printed by the image forming apparatus 20. The printing image database stores, for example, the ID of the account and image data in association with each account.

The communication I/F 98 is an interface for communication with other apparatuses. For example, a standard, such as Ethernet (Registered Trademark), FDDI, or Wi-Fi (Registered Trademark), is used.

### Name Resolution Request Process

Next, a name resolution request process on the host name by the image forming apparatus 20 will be described.

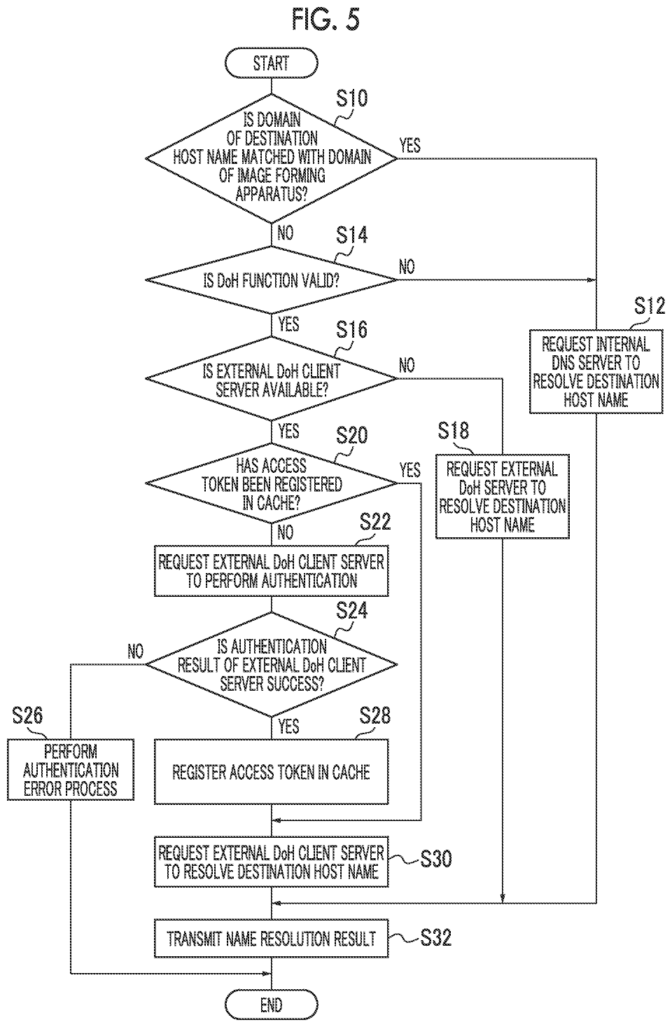

For example, in a case where the user operates the Web browser application implemented in the image forming apparatus 20 to select the file server FS, a name resolution request process illustrated in FIG. 5 is performed in the image forming apparatus 20 in response to a request from the Web browser application. In addition, the name resolution request process is an example of a name resolution request method.

First, in Step S10, the CPU 50 determines whether or not a domain of a host name (hereinafter, referred to as a “destination host name”) of the file server FS selected by the user is matched with a domain set in the image forming apparatus 20. Then, in a case where it is determined that the destination host name is matched with the domain set in the image forming apparatus 20, the CPU 50 proceeds to Step S12.

In Step S12, the CPU 50 requests the internal DNS server 24 to resolve the destination host name using the DNS client application implemented in the image forming apparatus 20 and proceeds to Step S32 which will be described below. The DNS client application requests the internal DNS server 24 to resolve the destination host name in plain text, without using encrypted communication.

On the other hand, in a case where it is determined in Step S10 that the destination host name is not matched with the domain set in the image forming apparatus 20, the CPU 50 proceeds to Step S14.

In Step S14, the CPU 50 determines whether or not the DoH function set in the image forming apparatus 20 is valid. Specifically, the CPU 50 determines whether or not the process of resolving the destination host name using DoH is valid with reference to the setting information of the image forming apparatus 20. Then, in a case where it is determined that the DoH function set in the image forming apparatus 20 is invalid, the CPU 50 proceeds to Step S12 and requests the internal DNS server 24 to resolve the destination host name using the DNS client application implemented in the image forming apparatus 20 as described above.

On the other hand, in a case where it is determined in Step S14 that the DoH function set in the image forming apparatus 20 is valid, the CPU 50 proceeds to Step S16.

In Step S16, the CPU 50 determines whether or not the external DoH client server 40 is available. Specifically, the CPU 50 determines whether or not the process of requesting the external DoH client server 40 to resolve a name is valid with reference to the setting information of the image forming apparatus 20. Then, in a case where it is determined that the external DoH client server 40 is not available, the CPU 50 proceeds to Step S18.

In Step S18, the CPU 50 requests the external DoH server 34 to perform encrypted name resolution on the destination host name using the DoH client application implemented in the image forming apparatus 20 and proceeds to Step S32 which will be described below. The DoH client application requests the external DoH server 34 to resolve the destination host name using DoH as encrypted communication.

Further, in a case where the DoH client application implemented in the image forming apparatus 20 is not available or in a case where the DoH client application is not implemented in the image forming apparatus 20, the CPU 50 transmits information indicating the fact to the Web browser application and ends the process.

On the other hand, in a case where it is determined in Step S16 that the external DoH client server 40 is available, the CPU 50 proceeds to Step S20.

In Step S20, the CPU 50 determines whether or not an access token indicating success in the authentication of the account for using the external DoH client server 40 has been registered in the cache. Then, in a case where it is determined that the access token has been registered in the cache, the CPU 50 proceeds to Step S30 which will be described below.

On the other hand, in a case where it is determined in Step S20 that the access token has not been registered in the cache, the CPU 50 proceeds to Step S22.

In Step S22, the CPU 50 performs an authentication request process of requesting the external DoH client server 40 to perform authentication. Specifically, the CPU 50 transmits authentication information, such as the ID of the account and a password, to the external DoH client server 40.

In this case, for example, the CPU 50 may display an authentication information input screen on the display unit 60 of the image forming apparatus 20 and transmit the authentication information of the account input by the user to the external DoH client server 40. Further, for example, the CPU 50 may transmit the authentication information of the account input by the user to the external DoH client server 40 during the authentication of the account for the image forming apparatus 20.

In addition, the account may be created not for each user who uses the image forming apparatuses 20 but for each image forming apparatus 20. In a case where the account is created for each image forming apparatus 20, the CPU 50 may transmit, for example, authentication information, such as the ID of the account and the password, input by the user to the external DoH client server 40 during the startup of the image forming apparatus 20.

Then, in Step S24, the CPU 50 determines whether the authentication result received from the external DoH client server 40 is a success or a failure. Then, in a case where it is determined that the authentication result is a failure, the CPU 50 proceeds to Step S26.

In Step S26, the CPU 50 performs an authentication error process. That is, the CPU 50 transmits information indicating that the authentication by the external DoH client server 40 has failed to the Web browser application and ends the process.

On the other hand, in a case where it is determined in Step S24 that the authentication result received from the external DoH client server 40 is a success, the CPU 50 proceeds to Step S28. In addition, in a case where the authentication by the external DoH client server 40 has succeeded, the CPU 50 receives the access token, the expiration date of the access token, and the like from the external DoH client server 40 as will be described below.

In Step S28, the CPU 50 registers the access token and the expiration date of the access token received from the external DoH client server 40 in the cache (access token cache).

Then, in Step S30, the CPU 50 requests the external DoH client server 40 to resolve the destination host name. In this case, the CPU 50 requests the external DoH client server 40 to resolve the destination host name using, for example, HTTP or HTTPS, without using DoH. In addition, the CPU 50 transmits the access token as the authentication information to the external DoH client server 40.

Further, the CPU 50 may request the external DoH client server 40 to resolve the destination host name using the address information (IP address) of the external DoH client server 40 preset in the image forming apparatus 20. Furthermore, the CPU 50 may request the external DoH client server 40 to resolve the destination host name using the host name (URL) of the external DoH client server 40. In this case, first, the CPU 50 requests the external DNS server 32 or the external DoH server 34 to resolve the destination host name, using the DNS client application or the DoH client application implemented in the image forming apparatus 20.

Then, in Step S32, the CPU 50 transmits the name resolution result of the destination host name received from the internal DNS server 24, the external DoH server 34, or the external DoH client server 40 to the Web browser application and ends the process.

Then, in a case where address information (IP address) corresponding to the destination host name is received as the name resolution result from the CPU 50, the Web browser application accesses the file server FS using the address information. On the other hand, in a case where information indicating that the name resolution has failed is received as the name resolution result from the CPU 50, the Web browser application displays the information on the Web browser and ends the process.

In addition, in a case where authentication is required to access the file server FS, the CPU 50 may use the access token issued in the authentication by the external DoH client server 40. In this configuration, for example, in a case where the CPU 50 requests the external DoH client server 40 to perform authentication, the CPU 50 also requests the file server FS to perform authentication.

### Authentication Process

Next, an authentication process by the external DoH client server 40 will be described.

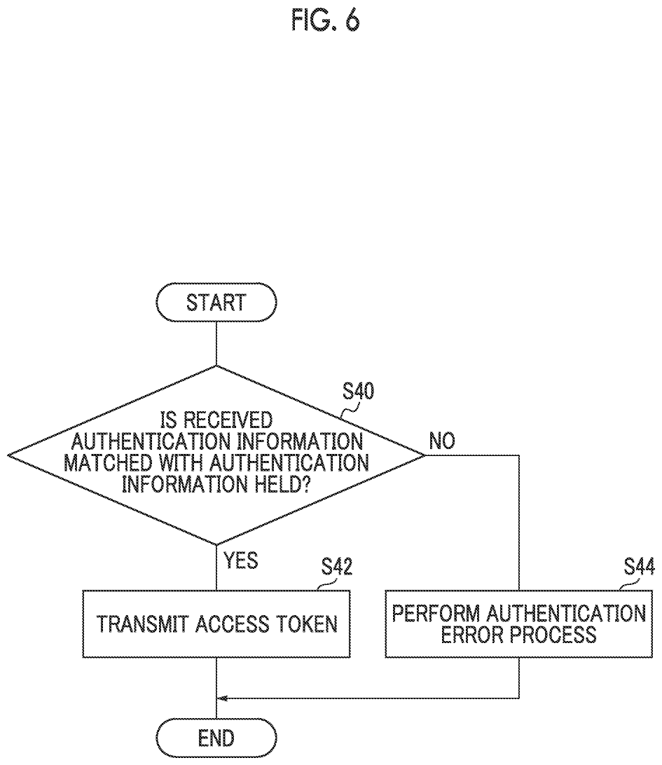

In a case where the external DoH client server 40 receives an account authentication request from the image forming apparatus 20, the external DoH client server 40 performs the authentication process illustrated in FIG. 6. In addition, the authentication process is an example of an authentication method.

First, in Step S40, the CPU 70 determines whether or not the authentication information of the account received from the image forming apparatus 20 is matched with the authentication information of the account held, that is, the authentication information of the account registered in advance in the authentication information database. Then, in a case where it is determined that the authentication information of the account received from the image forming apparatus 20 is matched with the authentication information of the account held, the CPU 70 proceeds to Step S42.

In Step S42, the CPU 70 issues an access token to the account. Specifically, the CPU 70 issues the access token to the account using a predetermined access token issuing protocol. Then, the issued access token and the expiration date of the access token are registered in the access token management database in association with the account and transmitted to the image forming apparatus 20. Then, the process ends. In addition, OAuth2.0 is given as an example of the access token issuing protocol. However, the access token issuing protocol is not limited thereto.

On the other hand, in a case where it is determined in Step S40 that the authentication information of the account received from the image forming apparatus 20 is not matched with the authentication information of the account held, the CPU 70 proceeds to Step S44. In Step S44, the CPU 70 performs the authentication error process. That is, the CPU 70 transmits information indicating that the authentication has failed to the image forming apparatus 20 and ends the process.

### Encrypted Name Resolution Process

Next, an encrypted name resolution process on the host name by the external DoH client server 40 will be described.

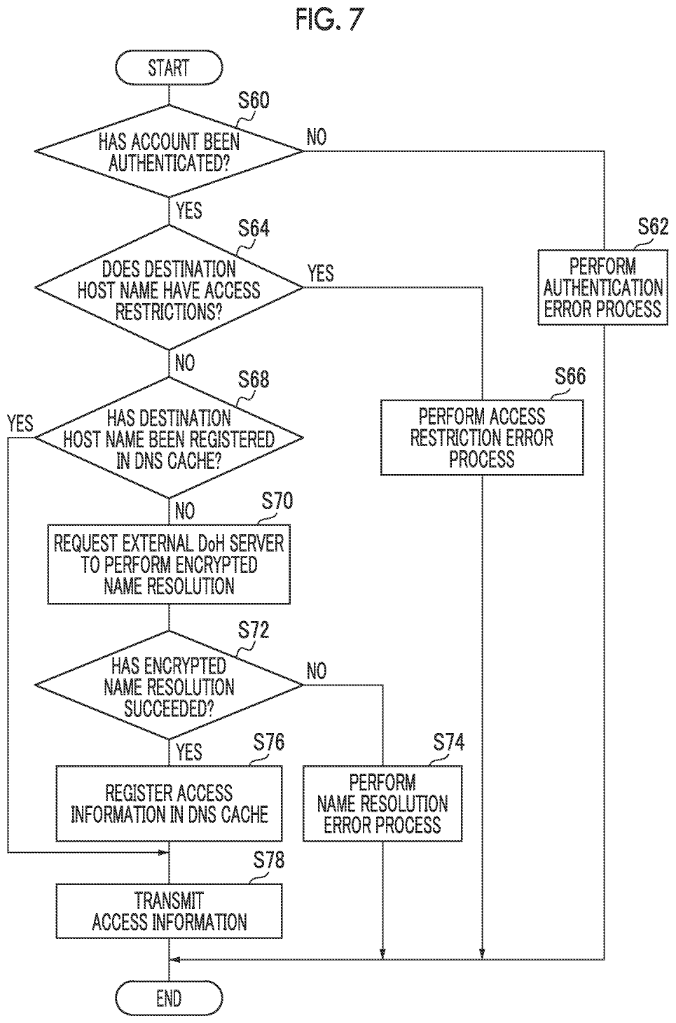

In a case where the external DoH client server 40 receives a name resolution request from the image forming apparatus 20, the encrypted name resolution process illustrated in FIG. 7 is performed in the external DoH client server 40. In addition, the encrypted name resolution process is an example of an encrypted name resolution method.

First, in Step S60, the CPU 70 determines whether or not the account corresponding to the received name resolution request has been authenticated. Specifically, the CPU 70 determines whether or not the access token included in the name resolution request received from the image forming apparatus 20 has been registered in the access token management database and is within the expiration date. Then, in a case where the access token included in the name resolution request received from the image forming apparatus 20 has not been registered in the access token management database or has expired, the CPU 70 proceeds to Step S62.

In Step S62, the CPU 70 performs the authentication error process. That is, the CPU 70 transmits information indicating that the authentication has failed to the image forming apparatus 20 and ends the process.

On the other hand, in a case where the access token included in the name resolution request received from the image forming apparatus 20 has been registered in the access token management database and is within the expiration date in Step S60, the CPU 70 proceeds to Step S64.

In Step S64, the CPU 70 determines whether or not the destination host name corresponding to the received request has access restrictions. That is, the CPU 70 determines whether or not the destination host name corresponding to the received request has been registered in the access restriction database. Then, in a case where the destination host name corresponding to the received request has been registered in the access restriction database, the CPU 70 proceeds to Step S66.

In Step S66, the CPU 70 performs an access restriction error process. That is, the CPU 70 transmits information indicating that the destination host name has the access restrictions to the image forming apparatus 20 and ends the process.

On the other hand, in a case where it is determined in Step S64 that the destination host name corresponding to the received request has not been registered in the access restriction database, the CPU 70 proceeds to Step S68.

In Step S68, the CPU 70 determines whether or not the destination host name corresponding to the received request has been registered in the DNS cache. Then, in a case where it is determined that the destination host name corresponding to the received request has been registered in the DNS cache, the CPU 70 proceeds to Step S78 which will be described below. On the other hand, in a case where it is determined that the destination host name corresponding to the received request has not been registered in the DNS cache, the CPU 70 proceeds to Step S70.

In Step S70, the CPU 70 requests the external DoH server 34 to perform the encrypted name resolution on the destination host name using the DoH client application implemented in the external DoH client server 40. The DoH client application requests the external DoH server 34 to perform the encrypted name resolution on the destination host name using DoH as encrypted communication.

Then, in Step S72, the CPU 70 determines whether or not the name resolution result of the destination host name received from the external DoH server 34 is a success. Then, in a case where it is determined that the name resolution result of the destination host name received from the external DoH server 34 is a failure, the CPU 70 proceeds to Step S74.

In Step S74, the CPU 70 performs the name resolution error process. That is, the CPU 70 transmits information indicating that the name resolution has failed to the image forming apparatus 20 and ends the process.

On the other hand, in a case where it is determined in Step S72 that the name resolution result of the destination host name received from the external DoH server 34 is a success, the CPU 70 proceeds to Step S76.

In Step S76, the CPU 70 registers the address information (IP address), which is the name resolution result of the destination host name, in the DNS cache.

Then, in Step S78, the CPU 70 transmits the address information, which is the name resolution result of the destination host name, to the image forming apparatus 20 and ends the process.

### Modification Examples

Next, modification examples of the above-described exemplary embodiment will be described.

In the above-described exemplary embodiment, in a case where a plurality of image forming apparatuses 20 are present, for example, the plurality of image forming apparatuses 20 may be divided into a plurality of groups for each organization or tenant (store), and a representative account (group account) for using the external DoH client server 40 may be created for each group. In this case, the external DoH client server 40 may manage the access restrictions of the destination host name for each representative account. Specifically, the access restriction database may be created for each representative account. Further, the external DoH client server 40 may manage DNS cache information for each representative account. Specifically, the external DoH client server 40 may create the DNS cache for each representative account.

Further, in the above-described exemplary embodiment, in Step S12 of FIG. 5, the CPU 50 requests the internal DNS server 24 to resolve the destination host name. Then, in a case where the CPU 50 receives information indicating that the resolution of the destination host name has failed as the name resolution result from the internal DNS server 24, for example, the CPU 50 may request the external DoH server 34 or the external DoH client server 40 to resolve the destination host name.

Further, the CPU 50 may compare a version of the DoH client application implemented in the image forming apparatus 20 with a version of the DoH client application implemented in the external DoH client server 40 and may request the external DoH client server 40 to resolve the destination host name in a case where the version of the DoH client application implemented in the image forming apparatus 20 is older than the version of the DoH client application implemented in the external DoH client server 40.

Further, in the above-described exemplary embodiment, the account authentication process is performed in the external DoH client server 40. However, the apparatus in which the account authentication process is performed is not limited to the external DoH client server 40, and the account authentication process may be performed by another server or the like.

Furthermore, in the above-described exemplary embodiment, DoH is used as the encrypted name resolution for resolving the host name using encrypted communication. However, the encrypted name resolution is not limited to DoH (HTTPS), and other types of encrypted communication may be used.

Moreover, in the above-described exemplary embodiment, the information processing system is the image forming apparatus 20. However, the information processing system is not limited to the image forming apparatus 20 and may be an information processing terminal such as a personal computer or a smartphone.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the above-described exemplary embodiment, the form in which each program is installed in the ROM or the storage has been described. However, the present disclosure is not limited thereto. Each program according to the above-described exemplary embodiment may be recorded on a computer-readable storage medium and then provided. For example, each program according to the above-described exemplary embodiment may be provided in a form recorded on an optical disc, such as a compact disc (CD)-ROM or a digital versatile disc (DVD)-ROM, or in a form recorded on a semiconductor memory such as a universal serial bus (USB) memory or a memory card. Further, each program according to the above-described exemplary embodiment may be acquired from an external apparatus via a communication I/F.

In addition, in the above-described exemplary embodiment, a case where the processes in the image forming apparatus 20 and the external DoH client server 40 are implemented by a software configuration in which a computer is used to execute a program has been described. However, the present disclosure is not limited thereto. For example, the processes in the image forming apparatus 20 and the external DoH client server 40 may be implemented by a hardware configuration or a combination of the hardware configuration and the software configuration.

Further, the configurations of the image forming apparatus 20 and the external DoH client server 40 described in the above exemplary embodiment are examples, and it goes without saying that unnecessary portions may be removed or new portions may be added without departing from the gist of the present disclosure.

In addition, the flow of the processes in the image forming apparatus 20 and the external DoH client server 40 described in the above exemplary embodiment is also an example, and it goes without saying that unnecessary steps may be removed, new steps may be added, or the processing order may be changed, without departing from the gist of the present disclosure.

The following supplementary notes are further disclosed regarding the above-described exemplary embodiment.

(((1)))

An information processing system comprising:
a processor configured to:
   in a case where a request to resolve a host name is received, request an encrypted name resolution client server that performs name resolution using encrypted communication with an encrypted name resolution server to resolve the host name.
      (((2)))

The information processing system according to (((1))), wherein the processor is configured to:
acquire a name resolution result of the host name from the encrypted name resolution client server.
   (((3)))

The information processing system according to (((2))), wherein the processor is configured to:
request the encrypted name resolution client server to resolve the host name without using DoH and acquire the name resolution result of the host name from the encrypted name resolution client server.
   (((4)))

The information processing system according to any one of (((1))) to (((3))), wherein the processor is configured to:
request the encrypted name resolution client server to resolve the host name in a case where a host name resolution process using the encrypted communication is valid; and
request a name resolution server that performs the name resolution without using the encrypted communication to resolve the host name in a case where the host name resolution process using the encrypted communication is invalid.
   (((5)))

The information processing system according to (((4))), wherein the processor is configured to:
request the encrypted name resolution client server to resolve the host name in a case where a name resolution request process for the encrypted name resolution client server is valid; and
request the name resolution server to resolve the host name or request the encrypted name resolution server to resolve the host name using the encrypted communication in a case where the name resolution request process for the encrypted name resolution client server is invalid.
   (((6))

The information processing system according to any one of (((1))) to (((5))), wherein the processor is configured to:
request the encrypted name resolution client server to resolve the host name in a case where a version of an encrypted name resolution client application implemented in a host apparatus is older than a version of an encrypted name resolution client application implemented in the encrypted name resolution client server.
   (((7)))

The information processing system according to any one of (((1))) to ((6))), wherein the processor is configured to:
perform an authentication request process of requesting the encrypted name resolution client server to perform authentication; and
request the encrypted name resolution client server to resolve the host name in a case where the authentication request process has succeeded.
   (((8)))

An information processing program causing a computer to execute a process comprising:
in a case where a request to resolve a host name is received, requesting an encrypted name resolution client server that performs name resolution using encrypted communication with an encrypted name resolution server to resolve the host name.
   (((9)))

An information processing system comprising:
a processor configured to:
   in a case where a request to resolve a host name is received from an information processing apparatus, request an encrypted name resolution server to resolve the host name using encrypted communication;
   acquire a name resolution result of the host name from the encrypted name resolution server; and
   transmit the name resolution result of the host name to the information processing apparatus.
      (((10)))

The information processing system according to (((9))), wherein the processor is configured to:
receive a request to resolve the host name, in which DoH is not used, from the information processing apparatus; and
request the encrypted name resolution server to resolve the host name using the DoH as the encrypted communication.
   (((11)))

An information processing program causing a computer to execute a process comprising:
in a case where a request to resolve a host name is received from an information processing apparatus, requesting an encrypted name resolution server to resolve the host name using encrypted communication;
acquiring a name resolution result of the host name from the encrypted name resolution server; and
transmitting the name resolution result of the host name to the information processing apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
in a case where a request to resolve a host name is received, request an encrypted name resolution client server that performs name resolution using encrypted communication with an encrypted name resolution server to resolve the host name.

2. The information processing system according to claim 1, wherein the processor is configured to:
acquire a name resolution result of the host name from the encrypted name resolution client server.

3. The information processing system according to claim 2, wherein the processor is configured to:
request the encrypted name resolution client server to resolve the host name without using DoH and acquire the name resolution result of the host name from the encrypted name resolution client server.

4. The information processing system according to claim 1, wherein the processor is configured to:
request the encrypted name resolution client server to resolve the host name in a case where a host name resolution process using the encrypted communication is valid; and
request a name resolution server that performs the name resolution without using the encrypted communication to resolve the host name in a case where the host name resolution process using the encrypted communication is invalid.

5. The information processing system according to claim 4, wherein the processor is configured to:
request the encrypted name resolution client server to resolve the host name in a case where a name resolution request process for the encrypted name resolution client server is valid; and
request the name resolution server to resolve the host name or request the encrypted name resolution server to resolve the host name using the encrypted communication in a case where the name resolution request process for the encrypted name resolution client server is invalid.

6. The information processing system according to claim 1, wherein the processor is configured to:
request the encrypted name resolution client server to resolve the host name in a case where a version of an encrypted name resolution client application implemented in a host apparatus is older than a version of an encrypted name resolution client application implemented in the encrypted name resolution client server.

7. The information processing system according to claim 1, wherein the processor is configured to:
perform an authentication request process of requesting the encrypted name resolution client server to perform authentication; and
request the encrypted name resolution client server to resolve the host name in a case where the authentication request process has succeeded.

8. The information processing system according to claim 2, wherein the processor is configured to:
perform an authentication request process of requesting the encrypted name resolution client server to perform authentication; and
request the encrypted name resolution client server to resolve the host name in a case where the authentication request process has succeeded.

9. The information processing system according to claim 3, wherein the processor is configured to:
perform an authentication request process of requesting the encrypted name resolution client server to perform authentication; and
request the encrypted name resolution client server to resolve the host name in a case where the authentication request process has succeeded.

10. The information processing system according to claim 4, wherein the processor is configured to:
perform an authentication request process of requesting the encrypted name resolution client server to perform authentication; and
request the encrypted name resolution client server to resolve the host name in a case where the authentication request process has succeeded.

11. The information processing system according to claim 5, wherein the processor is configured to:
perform an authentication request process of requesting the encrypted name resolution client server to perform authentication; and
request the encrypted name resolution client server to resolve the host name in a case where the authentication request process has succeeded.

12. The information processing system according to claim 6, wherein the processor is configured to:
perform an authentication request process of requesting the encrypted name resolution client server to perform authentication; and
request the encrypted name resolution client server to resolve the host name in a case where the authentication request process has succeeded.

13. A non-transitory computer readable medium storing an information processing program causing a computer to execute a process comprising:
in a case where a request to resolve a host name is received, requesting an encrypted name resolution client server that performs name resolution using encrypted communication with an encrypted name resolution server to resolve the host name.

14. An information processing system comprising:
a processor configured to:
in a case where a request to resolve a host name is received from an information processing apparatus, request an encrypted name resolution server to resolve the host name using encrypted communication;
acquire a name resolution result of the host name from the encrypted name resolution server; and
transmit the name resolution result of the host name to the information processing apparatus.

15. The information processing system according to claim 14, wherein the processor is configured to:
receive a request to resolve the host name, in which DoH is not used, from the information processing apparatus; and
request the encrypted name resolution server to resolve the host name using the DoH as the encrypted communication.
